(19) United States
(12) Patent Application Publication
(10) Pub. No.: US 2011/0157522 A1
(43) Pub. Date: Jun. 30, 2011

(54) LIQUID CRYSTAL DISPLAY DEVICE

(75) Inventors: Takuto KATO, Kawasaki (JP); Toshiaki YOSHIHARA, Kawasaki (JP)

(73) Assignee: FUJITSU LIMITED, Kawasaki-shi (JP)

(21) Appl. No.: 12/973,225

(22) Filed: Dec. 20, 2010

(30) Foreign Application Priority Data
Dec. 24, 2009 (JP) 2009-292463

(51) Int. Cl. G02F 1/1347

(52) U.S. Cl. 349/76

(57) ABSTRACT

A liquid crystal display device includes a liquid crystal layer containing a composition that includes a nematic liquid crystal and a chiral agent, the composition having properties satisfying η/Δε^{1/2}/E²≦1.0 and having a refractive index anisotropy of 0.23 or more, η representing the viscosity of the liquid crystal composition, Δε representing the dielectric constant anisotropy of the composition, and E representing the electric field intensity at which the state of the composition is changed from a planar state to a focal conic state and a pair of electrode substrates between which the liquid crystal layer is disposed, at least one of the electrode substrates being transparent.

### CROSS-REFERENCE TO RELATED APPLICATIONS

This application is based upon and claims the benefit of priority of the prior Japanese Patent Application No. 2009-292463 filed on Dec. 24, 2009, the entire contents of which are incorporated herein by reference.

### FIELD

A certain aspect of the embodiment disclosed herein relates to a liquid crystal display device.

### BACKGROUND

Many companies and research institutes have recently conducted intensive research and development of liquid crystal display devices used for, for example, electronic papers. Many applications of electronic papers represented by electronic books have been proposed, including sub displays of mobile terminal equipment and IC card displays. In a method for displaying images on an electronic paper, a liquid crystal composition (cholesteric liquid crystal) forming a cholesteric phase is used. The cholesteric liquid crystal, which may be called chiral nematic liquid crystal, is a type of liquid crystal whose nematic liquid crystal molecules form a helical cholesteric phase by adding a relatively large amount (several tens of percent) of chiral additive (chiral agent) to the nematic liquid crystal.

In a display device using a cholesteric liquid crystal, the alignment of liquid crystal molecules in the liquid crystal layer is controlled by, for example, applying a predetermined driving voltage to the liquid crystal layer. Consequently, light coming into the liquid crystal display device is modulated to display intended images. One of the features of cholesteric liquid crystals is that its liquid crystal molecules form a helical structure with each other. The helical structure forms three states: a planar state, a focal conic state, and a homeotropic state, by applying an external impact, such as electric field, magnetic field, or heat. These three states have different optical transparencies and different reflectivities. By appropriately selecting a state from the three states and an external impact to be applied, images are displayed.

Images may be displayed in a cholesteric-nematic phase transition mode using a homeotropic state and a focal conic state, or in a bistable mode using a planar state and a focal conic state. In particular, the bistable mode allows the planar state and the focal conic state to be stable even when no external impact is applied, and hence has a bistable characteristic (memory characteristic) in which the display state is maintained even when no external impact is applied (for example, when no voltage is applied). In particular, reflective liquid crystal display devices using a cholesteric liquid crystal that selectively reflects visible light in a planar state exhibit the memory characteristic and may display bright images without using a polarizing plate or a color filter. Accordingly, liquid crystal display devices using a cholesteric liquid crystal are thought of as memory elements (elements whose display state is stable).

Japanese Laid-open Patent Publication No. 2003-295225 discloses a technique for achieving a bright, thermally stable liquid crystal display device capable of selectively reflecting light having a long wavelength, exhibiting a high response, and capable of being driven at a reduced voltage. This technique is intended to achieve such a display device by controlling the viscosity, dielectric constant anisotropy, refractive index anisotropy and isotropic phase transition temperature of a liquid crystal composition. Japanese Laid-open Patent Publication No. 2002-287166 discloses a technique for displaying high-contrast image and driving the display device at a low voltage.

### SUMMARY

In accordance with an aspect of the embodiments, a liquid crystal display device includes, a liquid crystal layer containing a composition that includes a nematic liquid crystal and a chiral agent, the composition having properties satisfying η/Δε^{1/2}/E²≦1.0 and having a refractive index anisotropy of 0.23 or more, η representing the viscosity of the composition, Δε representing the dielectric constant anisotropy of the composition, and E representing the electric field intensity at which the state of the composition is changed from a planar state to a focal conic state and a pair of electrode substrates between which the liquid crystal layer is disposed, at least one of the electrode substrates being transparent.

The object and advantages of the invention will be realized and attained by means of the elements and combinations particularly pointed out in the claims. It is to be understood that both the foregoing general description and the following detailed description are exemplary and explanatory and are not restrictive of the various embodiments, as claimed.

### BRIEF DESCRIPTION OF DRAWINGS

These and/or other aspects and advantages will become apparent and more readily appreciated from the following description of the embodiments, taken in conjunction with the accompanying drawings.

FIG. 1 is a schematic view of the structure of a liquid crystal display device according to an embodiment.

FIG. 2 is a fragmentary view of the liquid crystal element shown in FIG. 1, showing the green display portion.

FIGS. 3A and 3B are schematic representation of the principle of cholesteric liquid crystal to display an image.

FIG. 4 is a plot of experimental results showing the relationship between the XGA writing time(s) of an XGA resolution display and the value of η/Δε^{1/2}×1/E².

FIG. 5 is a plot of experimental results showing the relationship between the writing time(s) and the value of η/Δε^{1/2} when the electric field intensity E is 4.8 V/μm.

FIG. 6A is a graph of subjective evaluation results of the brightness of a green display portion, and FIG. 6B is a graph of subjective evaluation results of the contrast ratio of the green display portion.

FIG. 7A is a graph of subjective evaluation results of the brightness of a blue display portion, and FIG. 7B is a graph of subjective evaluation results of the contrast ratio of the blue display portion.

FIG. 8A is a graph of subjective evaluation results of the brightness of a red display portion, and FIG. 8B is a graph of subjective evaluation results of the contrast ratio of the red display portion.

FIG. 9A is a plot of the relationship between the refractive index anisotropy Δn and the brightness of an independent green display portion (single portion), and FIG. 9B is a plot of the relationship between the refractive index anisotropy Δn and the contrast ratio of the independent green display portion.

FIG. 10A is a plot of the relationship between the refractive index anisotropy Δn and the brightness of an independent blue display portion (single portion), and FIG. 10B is a plot of the relationship between the refractive index anisotropy Δn and the contrast ratio of the independent blues display portion.

FIG. 11A is a plot of the relationship between the refractive index anisotropy Δn and the brightness of an independent red display portion (single portion), and FIG. 11B is a plot of the relationship between the refractive index anisotropy Δn and the contrast ratio of the independent red display portion.

FIG. 12 is a plot showing the relationship between the phase transition temperature Tc of a liquid crystal composition and the upper limit of the temperature at which the liquid crystal display device may be driven.

FIG. 13 is a plot showing the relationship between the temperature and the brightness normalized with the brightness at 25° C.

FIGS. 14A to 14F are representations of a method for manufacturing a liquid crystal display device.

### DESCRIPTION OF EMBODIMENTS

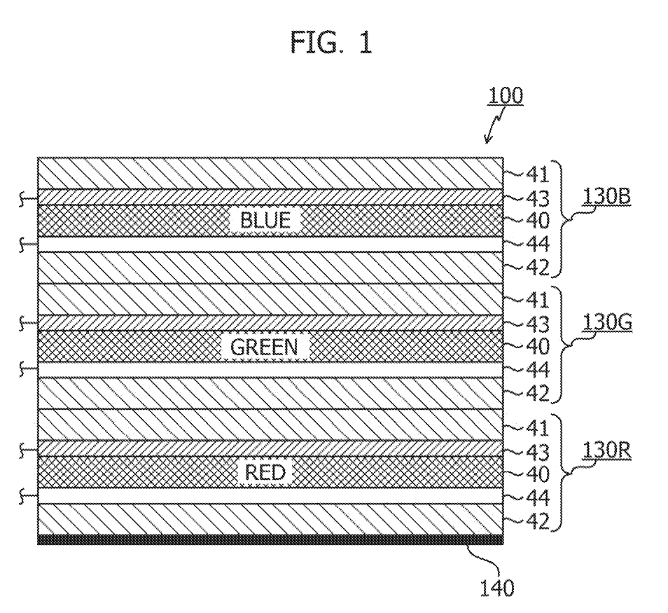

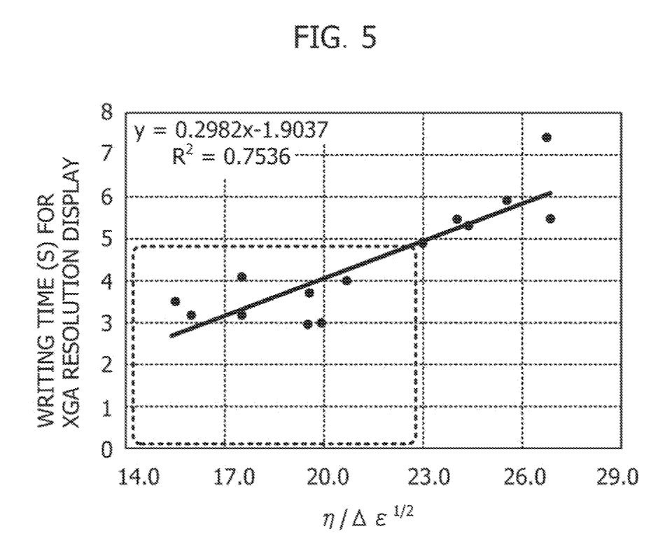

A liquid crystal display device according to an embodiment will now be described with reference to FIG. 1 to FIG. 14F. FIG. 1 schematically shows a liquid crystal display device 100. The liquid crystal display device 100 has a multilayer structure including a blue (B) display portion 130B, a green (G) display portion 130G, a red (R) display portion 130R, and a light absorbing layer 140. The display portions 130B, 130G and 130R each include film substrates 41 and 42, ITO electrode layers 43 and 44, and a liquid crystal layer 40.

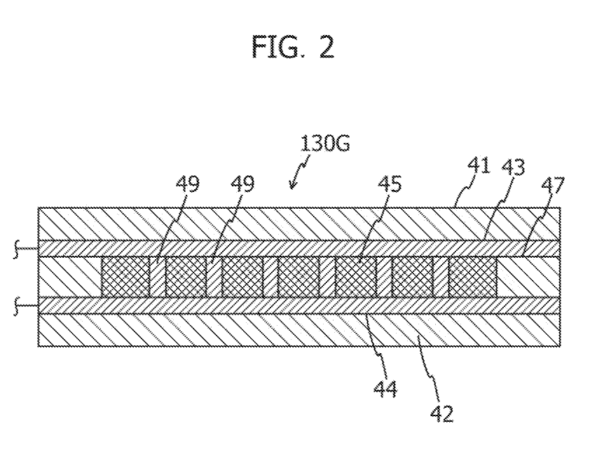

FIG. 2 is a schematic sectional view of the structure of the green display portion 130G. The green display portion 130G includes film substrates 41 and 42, ITO electrode layers 43 and 44, and a liquid crystal layer 40. The liquid crystal layer has a sealing member 47 and structural members 49 and contains a composition 45 that includes a nematic liquid crystal and a chiral agent.

The film substrates 41 and 42 are each optically transparent. The film substrates 41 and 42 may be made of PET (polyethylene terephthalate). Alternatively, glass film substrates, polycarbonate film substrates, or other film substrates may be used without particular limitation.

The ITO electrode layers 43 and 44 each include a plurality of strip electrodes arranged in parallel with each other, and the strip electrodes of the ITO electrode layer 43 intersect orthogonally with the strip electrodes of the ITO electrode layer 44 when viewed in the direction perpendicular to the surface of the film substrates 41 and 42 (in the direction normal to the sheet of FIG. 2). The strip electrodes of the ITO electrodes 43 and 44 are made of indium tin oxide (ITO). Instead of the ITO electrodes, electrodes made of any other transparent electroconductive material may be used, such as indium zinc oxide (IZO).

The electrodes of the ITO electrode layers 43 and 44 may be covered with an insulating thin film. However, a thick insulating thin film increases the driving voltage, and consequently, the resulting device may not be driven with a general supertwist nematic (STN) driver. In contrast, absence of the insulting thin film causes a leakage current and thus increases the power consumption. Preferably, the thickness of the insulating thin film is about 0.3 μm or less because the insulating thin film has a relative dielectric constant of about 5, which is lower than that of the liquid crystal. The insulating thin film may be a SiO2 thin film, or a known organic film functioning to stabilize the orientation of the liquid crystal molecules, such as a polyimide resin film or an acrylic resin film.

The composition 45 (chiral nematic liquid crystal composition) contains cholesteric liquid crystal that is in a cholesteric phase at room temperature. The composition 45 will be detailed later.

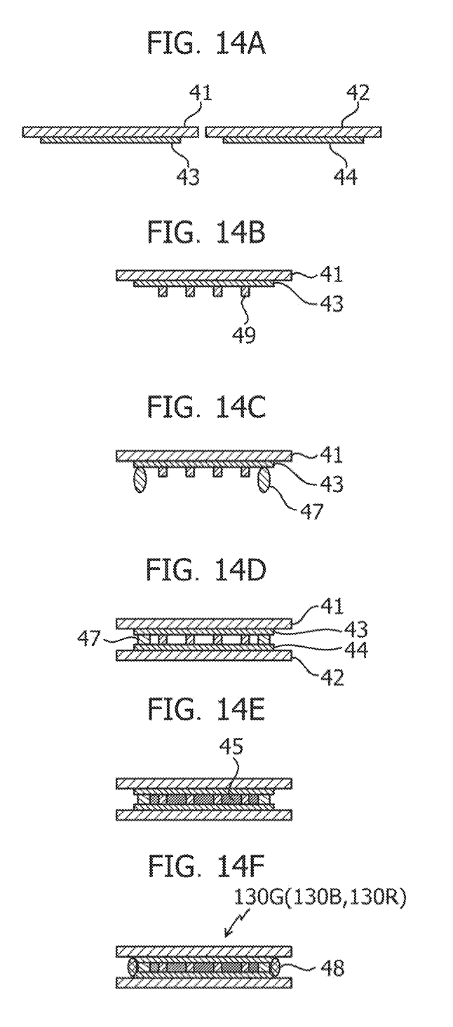

The sealing member 47 is used for enclosing the composition 45 in the space between the film substrates 41 and 42. The sealing member 47 has an opening through which the composition 45 is injected into the space between the film substrates 41 and 42. The opening is closed with a sealant after the composition 45 has been entered. The sealant is not shown in FIG. 2, but is designated by reference numeral 48 in FIG. 14F.

The structural members 49 are made of an acrylic negative resist, and are intended to keep the gap between the film substrates 41 and 42 constant and to partition pixels.

The other display portions (blue display portion 130B and red display portion 130R) shown in FIG. 1 each have substantially the same structure as the green display portion 130G. Accordingly, the same parts of the blue display portion 130B and the red display portion 130R as those of the green display portion 130G are designated by the same reference numerals.

The light absorbing layer 140 shown in FIG. 1 is disposed on the rear surface of the lower film substrate 42 of the red display portion 130R so as to absorb light entering through the blue display portion 130B and passing through the blue display portion 130R, the green display portion 130G and the red display portion 130R.

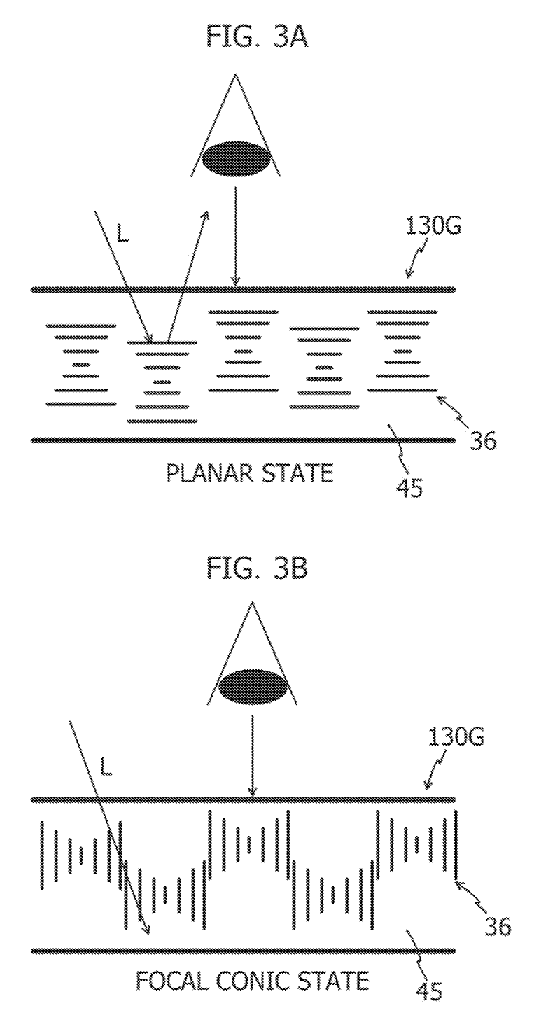

Turning now to FIGS. 3A and 3B, the principle of cholesteric liquid crystal to display an image will be described. FIG. 3A shows the orientation of the liquid crystal molecules 36 of the liquid crystal composition 45 in the green display portion 130G when the liquid crystal is in a planar state, and FIG. 3B shows the orientation of the liquid crystal molecules 36 in the green display portion 130G when the liquid crystal is in a focal conic state.

As shown in FIG. 3A, the liquid crystal molecules 36 in a planar state rotate spirally in the thickness direction to form a helical structure. The axis of the helical structure extends substantially perpendicular to the surface of the substrate. In the planar state, incident light L having a predetermined wavelength according to the helical pitch of the liquid crystal molecules is selectively reflected at the liquid crystal layer. The maximum reflection wavelength λ (wavelength at which the maximum reflection occurs) may be calculated from the following equation (1), wherein n represents the average refractive index of the liquid crystal layer, and p represents the helical pitch:

λ=n·p (1)

In order to reflect a specific light selectively when the liquid crystal composition of the green display portion 130G is in a planar state, the average refractive index n and the helical pitch p are determined so that maximum reflection wavelength λ may be a specified value (λ=560 for the green display portion). The average refractive index n may be adjusted by appropriately selecting the liquid crystal material and the chiral agent, and the helical pitch p may be adjusted by controlling the chiral agent content.

On the other hand, as shown in FIG. 3B, the liquid crystal molecules 36 in a focal conic state rotates spirally in the in-plane direction of the substrate to form a helical structure. The axis of the helical structure extends substantially parallel to the surface of the substrate. In this instance, the green display portion 130G loses the wavelength selectivity of reflection and transmits almost all the incident light L.

Thus, the cholesteric liquid crystal controls whether incident light L is reflected or transmitted according to the helically twisted orientation of the liquid crystal molecules 36.

The blue display portion 130B and the red display portion 130R may display images on the same principle. In the liquid crystal display device 100 shown in FIG. 1, when light entering from the blue display portion side is transmitted through the blue display portion 130B, the green display portion 130G and the red display portion 130R, the transmitted light is absorbed by the light absorbing layer 140 to form a dark image. When any display portion (130B, 130G or 130R) reflects light, the color of the display portion from which the light is reflected is shown.

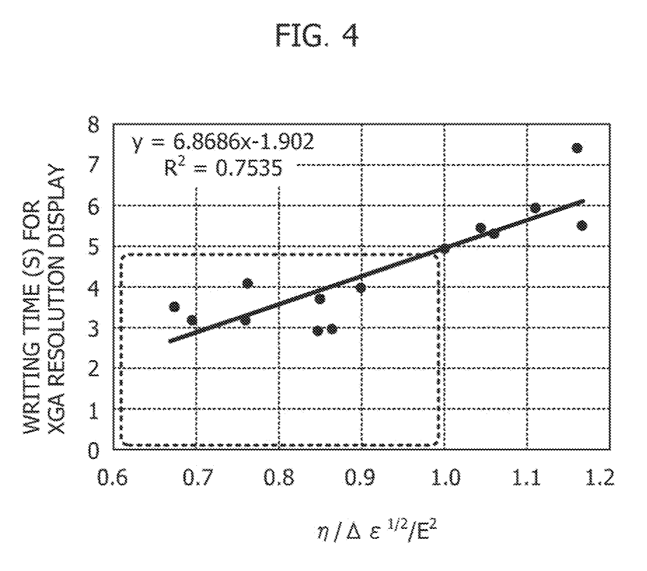

The liquid crystal composition 45 will now be described with reference to FIG. 4 to FIG. 13. Conditions for the composition are determined from the viewpoints of: (1) writing time; (2) brightness and contrast ratio; and (3) operating temperature.

The conditions of the composition will first be described from the viewpoint of (1) writing time. FIG. 4 is a plot showing experimental results of the relationship between the writing time(s) of an XGA (eXtended Graphics Array having resolutions of 1024×768 pixels) resolution display and the value of η/Δε^{1/2}×1/E². In the above expression, η represents the viscosity of the liquid crystal composition, Δε represents the dielectric constant anisotropy of the composition, and E represents the intensity of the electric field at which the liquid crystal turns to a focal conic state (see FIG. 3B) from a planar state (see FIG. 3A).

As shown in FIG. 4, the approximation of experimental results by the least square method shows that the writing time(s) is substantially proportionate to the expression η/Δε^{1/2}×1/E². The present embodiment sets the target writing time at 5 seconds or less for an XGA resolution display, and sets the value of η/Δε^{1/2}×1/E² at 1.0 or less according to the plot shown in FIG. 4. These settings may achieve an easily operable liquid crystal display device having a short writing time.

If the liquid crystal display device 100 is driven by a general driver that may apply voltages up to 40 V, the electric field intensity E is generally estimated to be about 4.8 V/μm. Accordingly, when the electric field intensity E is set to 4.8 V/μm, the writing time(s) of an XGA resolution display may be set at 5 seconds by setting the η/Δε^{1/2} value at 23.0 or less. These settings may achieve an easily operable liquid crystal display device having a short writing time.

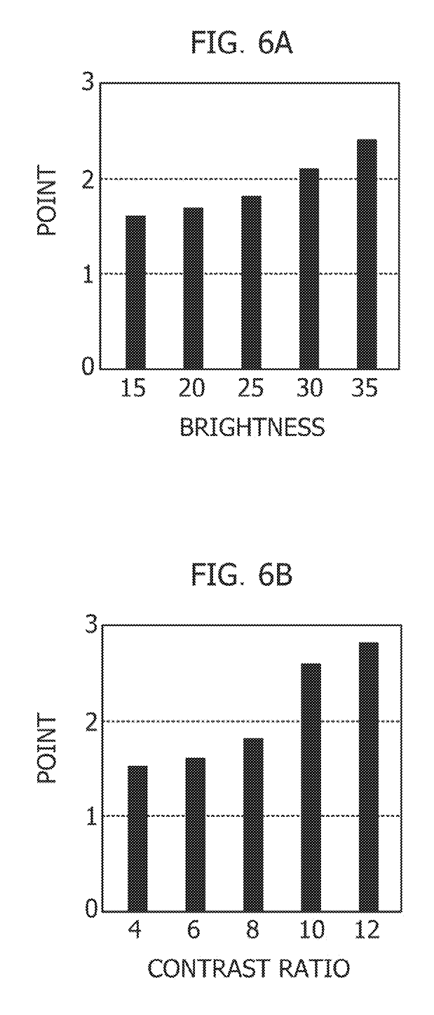

The conditions of the composition will be described from the viewpoint of (2) perceived (i.e., subjective) brightness and perceived (i.e., subjective) contrast ratio. The brightness of a liquid crystal display device is evaluated as shown in FIG. 6A. The “brightness” mentioned herein refers to the percentage of luminance reflectance in a planar state relative to the reflectance (100%) of a standard white plate made of barium sulfate. This evaluation was performed by a plurality of evaluators by scoring on a scale of zero (0) to three (3), with three (3) being the best score. FIG. 6A, which shows the evaluation results of an independent green display portion, shows that when the brightness is 30 or more, the evaluation score is in a range of 2 to 3 (evaluated to be good). This means that the brightness is desirably 30 or more.

The contrast ratio of the liquid crystal display device is evaluated as shown in FIG. 6B. This evaluation was also performed by a plurality of evaluators by scoring on a scale of zero (0) to three (3), with three (3) being the best score. FIG. 6B, which shows the evaluation results of the independent green display portion, shows that when the contrast ratio is 10 or more, the evaluation score comes to the range of 2 to 3 (evaluated to be good). This means that the contrast ratio is desirably 10 or more.

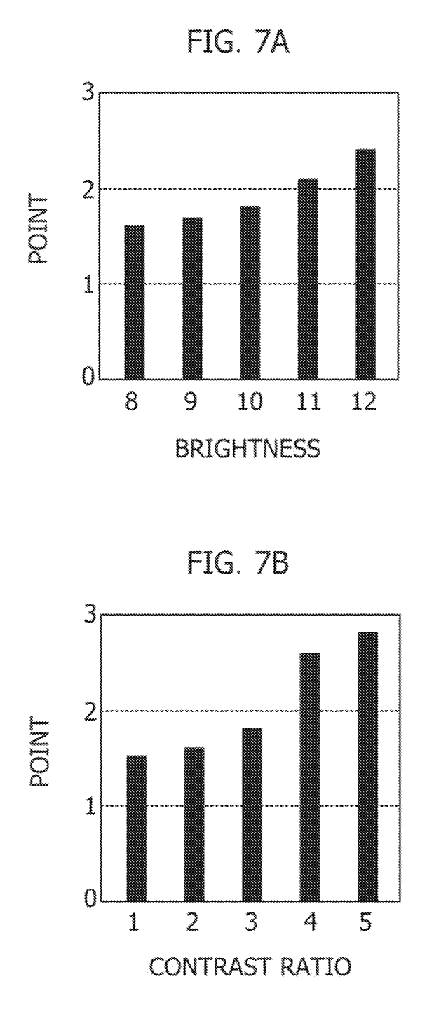

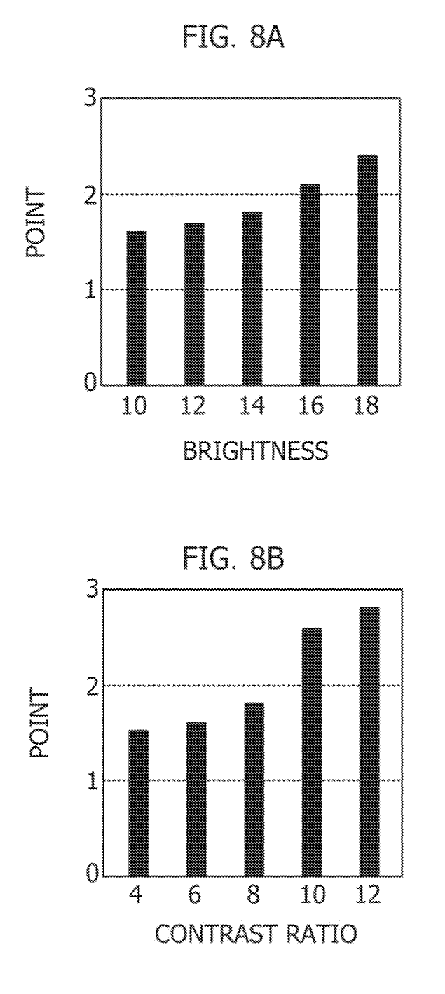

Furthermore, an independent blue display portion and an independent red display portion were evaluated. The results are shown in FIGS. 7A and 7B and 8A and 8B. As shown in FIGS. 7A and 7B, in the independent blue display portion, when the brightness was 11 or more and the contrast ratio was 4 or more, the evaluation score came to the range of 2 to 3. As shown in FIGS. 8A and 8B, in the independent red display portion, when the brightness was 16 or more and the contrast ratio was 4 or more, the evaluation score is in a range of 2 to 3.

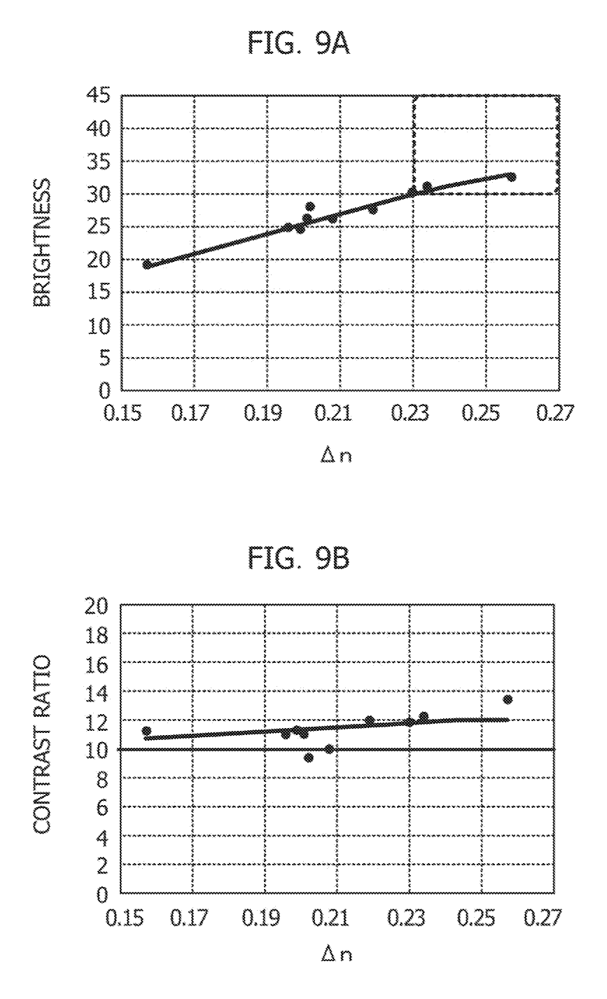

FIG. 9A shows the relationship between the refractive index anisotropy Δn of the composition and the brightness, of an independent green display portion. FIG. 9B shows the relationship between the refractive index anisotropy Δn and the contrast ratio of the green display portion. These evaluation results suggest that the refractive index anisotropy Δn be required to be 0.23 or more for a green display portion exhibiting a brightness of 30 or more and a contrast ratio of 10 or more.

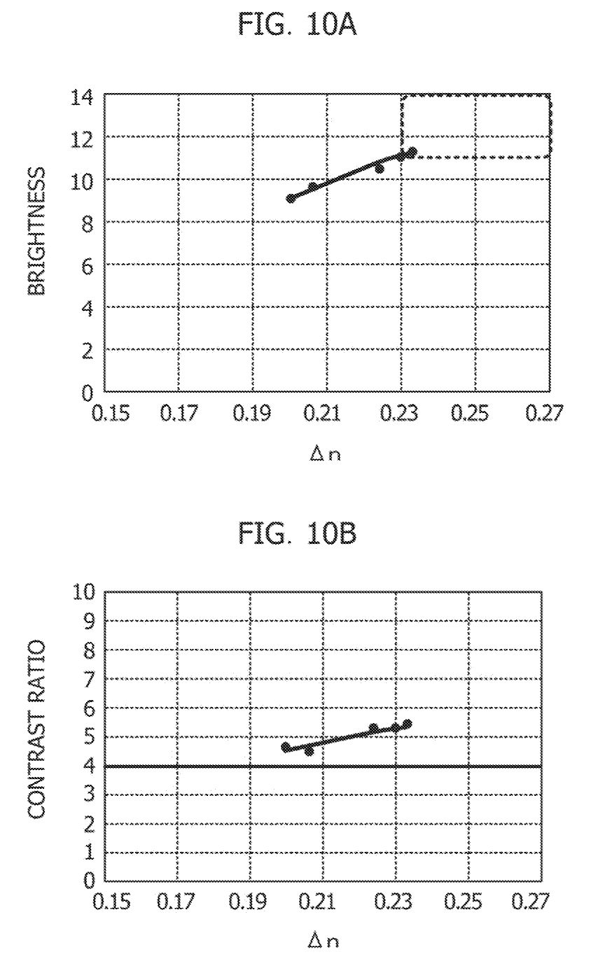

FIG. 10A shows the relationship between the refractive index anisotropy Δn of the composition and the brightness, of an independent blue display portion. FIG. 10B shows the relationship between the refractive index anisotropy Δn and the contrast ratio of the blue display portion. These subjective evaluation results suggest that the refractive index anisotropy Δn be required to be 0.23 or more for a blue display portion exhibiting a brightness of 11 or more and a contrast ratio of 4 or more, as with the green display portion.

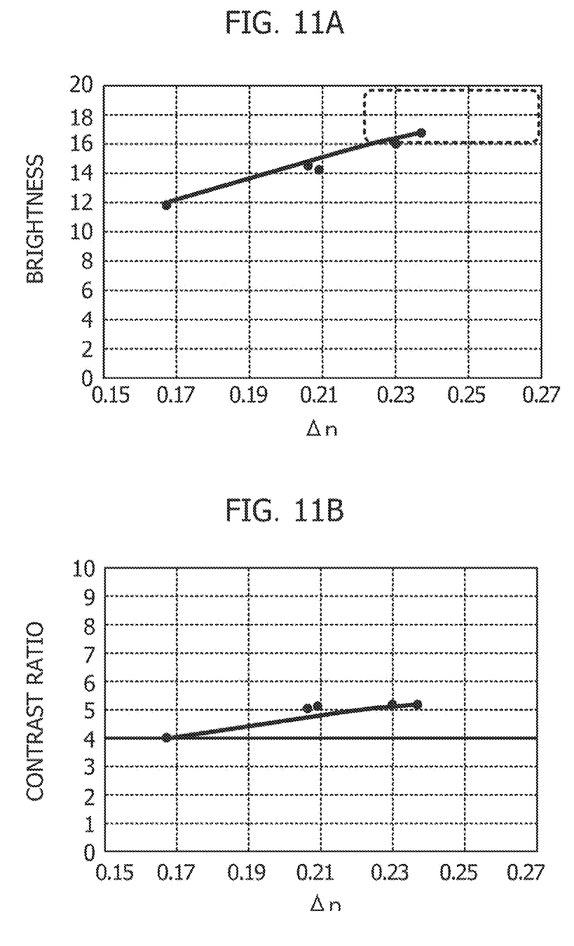

FIG. 11A shows the relationship between the refractive index anisotropy Δn of the composition and the brightness, of an independent red display portion. FIG. 11B shows the relationship between the refractive index anisotropy Δn and the contrast ratio of the red display portion. These subjective evaluation results suggest that the refractive index anisotropy Δn be required to be 0.22 or more for a red display portion exhibiting a brightness of 16 or more and a contrast ratio of 4 or more.

The evaluation results above suggest that the refractive index anisotropy Δn be preferably 0.23 or more for sufficient brightness and good contrast ratio in all the independent display portions. Although the evaluations were performed on independent display portions for convenience in evaluation and description, similar results may be obtained in evaluations of a liquid crystal display device 100 including a plurality of color display portions as in the above embodiment.

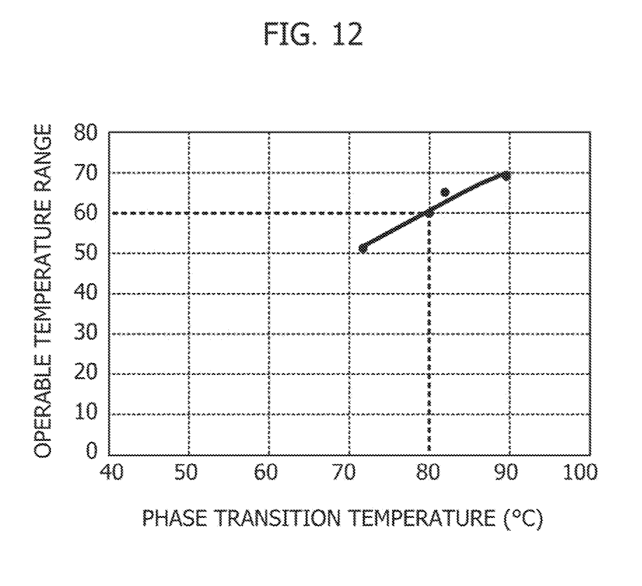

The conditions of the composition will be described from the viewpoint of (3) operating temperature. It was estimated that an easily operable liquid crystal display device may be driven at temperatures up to about 60° C., and conditions for achieving a liquid crystal display device capable of being driven in such a temperature range was determined. As a result, a plot shown in FIG. 12 was obtained which shows the relationship between the isotropic phase transition temperature (hereinafter referred to as phase transition temperature) Tc and the upper limit of operable temperature (temperature at which the liquid crystal display device may operate. FIG. 12 is common to the blue, green and red display portions 130B, 130G and 130R.

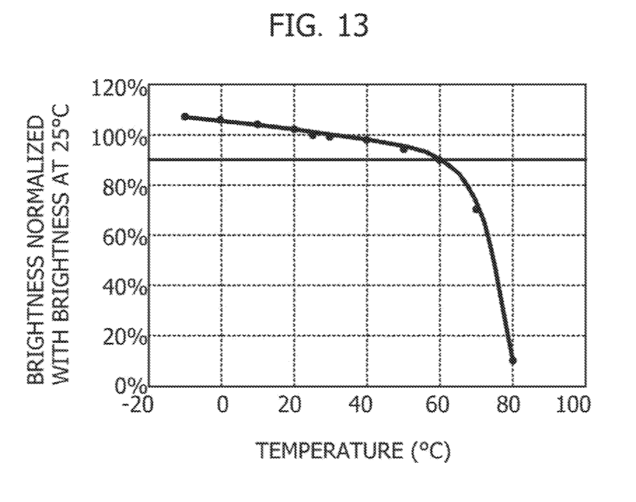

As shown in FIG. 12, when the phase transition temperature is 80° C. or more, the upper limit of operable temperatures is 60° C. or more. Accordingly, in the present embodiment, the phase transition temperature Tc of the composition is set at 80° C. or more. The operable temperatures refer to temperatures at which a brightness of 90% or more may be achieved, relative to the brightness or reflectance (100%) in a planar state at 25° C. In other words, when the upper limit of operable temperatures is 60° C., the brightness forms a characteristic curve shown in FIG. 13.

A liquid crystal composition (used in the green display portion 130G) satisfying the above conditions was prepared as below.

(a) Commercially available nematic liquid crystal A (refractive index anisotropy Δn: 0.25; dielectric constant anisotropy Δε: 7.0; viscosity η: 20 mPa·s at room temperature; phase transition temperature Tc: 111° C.) was mixed with commercially available nematic liquid crystal B (refractive index anisotropy Δn: 0.23; dielectric constant anisotropy Δε: 36.3; viscosity η: 60 mPa·s at room temperature; phase transition temperature Tc: 80° C.) in a proportion of 1:1. Thus nematic liquid crystal C (Δn: 0.24; Δε: 25.0; η: 60 mPa·s at room temperature; Tc: 95° C.) was prepared.

(b) Commercially available chiral agent A (Δε: 25; Tc: 70° C.) and chiral agent B (Δε: 31; Tc: 108° C.) were added to nematic liquid crystal C of the above preparation (a) in a proportion of 26% by weight relative to the total weight of nematic liquid crystal C and chiral agents A and B. Thus, composition X was prepared whose reflection peak wavelength could be around 560 nm (green region). Chiral agents A and B are solid at room temperature. The mixture of chiral agents A and B had a dielectric constant anisotropy Δε of 25 and a phase transition temperature Tc of 88° C. The content of chiral agents A and B of 26% by weight included 21% by weight of chiral agent A and 5% by weight of chiral agent B. The content of nematic liquid crystal C was 74% by weight.

Thus, prepared composition X had a refractive index anisotropy Δn of 0.23 and a dielectric constant anisotropy Δε of 24.5 at temperatures in the range of 0 to 70° C. The phase transition temperature Tc was 89° C. The viscosity η was about 74 mPa·s at room temperature, about 20 mPa·s at 50° C., and about 550 mPa·s at 0° C.

The value of η/Δε^{1/2}×1/E² of composition X was 0.69, satisfying the condition η/Δε^{1/2}×1/E²≦1.0. When the electric field intensity E was 4.8 V/μm, the value of η/Δε^{1/2} was 16.0, satisfying the condition η/Δε^{1/2}≦23.

Composition X was placed in a liquid crystal cell for evaluation. As a result, favorable characteristics were obtained with a writing time of about 3.2 s for an XGA resolution display and a brightness (reflectance) of 31, and a contrast ratio of 11.8.

For a composition used in the blue display portion 130B, the helical pitch may be adjusted by adding a trace amount of chiral agent so that the reflection peak wavelength may be around 435 nm. For a composition used in the red display portion 130R, the helical pitch may be adjusted by adding a trace amount of chiral agent so that the reflection peak wavelength may be around 750 nm. These compositions may produce the same effect as composition X.

An embodiment of the method for manufacturing the blue display portion 130B, the green display portion 130G and the red display portion 130R will be described with reference to FIGS. 14A to 14F. First, as shown in 14A, 100 μm thick polyethylene terephthalate (PET) film substrates 41 and 42 are prepared. Transparent electroconductive films 43 and 44 are respectively disposed on the surfaces of the substrates 41 and 42. Driving electrodes are formed on the respective substrates in the directions perpendicular to each other for passive driving. Three pairs of these two substrates are prepared. Turning now to FIG. 14B, an acrylic negative resist layer is formed on either of the substrates of each pair with a spinner. The resist layer is then formed into structural members 49 partitioning pixels by a photo process. The resist layer may be made of a negative resist of another material other than acrylic resin, or a positive resist. If a positive resist is used, spherical spacers may be additionally spread over the surface of the substrate. The spacers may be solids whose surfaces are coated with a thermoplastic resin. The gaps between the spacers are preferably in the range of, for example, 3.5 to 6 μm. Smaller gaps outside this range reduce the reflectance to display dark images. In contrast, larger gaps outside this range increase the driving voltage to make it difficult to drive the device with a general component. Turning to FIG. 14C, a sealing member 47 is applied along the edge of the substrate on which the structural members 49 have been formed so that an opening for injecting the composition is formed at an end of the substrate. Then, the resulting substrate and the other substrate of the substrate pair are bonded together by pressing and heating, as shown in FIG. 14D. Turning now to FIG. 14E, each of the three vacant panels prepared through the steps shown in FIGS. 14A to 14D is evacuated, and an end of the panel is immersed in a blue, green or red cholesteric liquid crystal. The composition 45 is injected by opening the panel to the air. Subsequently, the injection opening is sealed with a sealant 48, as shown in FIG. 14F. Thus, color display portions 130B, 130G and 130R are prepared. The blue, green and red display portions 130B, 130G and 130R are stacked each other in that order from the viewing side, thus completing a liquid crystal display device 100 shown in FIG. 1.

In the method of the present embodiment, a specific composition is used for a liquid crystal display device 100, and which satisfies the relationship η/Δε^{1/2}/E²≦1.0 (where η represents the viscosity of the composition, Δε represents the dielectric constant anisotropy, and E represents the electric field intensity) and has a refractive index anisotropy Δn of 0.23 or more. This composition may achieve a short writing time and good display properties (high brightness and high contrast ratio). In general, the electric field intensity E is set at 4.8. In such a case, the value of η/Δε^{1/2} and the refractive index anisotropy Δn may be set at 23 or less and at 0.23 or more, respectively, for the same effect as above. In addition, in the above embodiment, a composition having such properties as the expression η/Δε^{1/2}/E2 (or η/Δε^{1/2}) satisfies a predetermined condition is used. Accordingly, the composition may be selected from a wider range of choices than cases where η and Δε must satisfy their respective conditions.

Furthermore, since the composition 45 used in the above embodiment has an isotropic phase transition temperature Tc of 80° C. or more, the resulting liquid crystal display device 100 may be driven at temperatures up to 60° C. and is thus easily operable.

The liquid crystal display device 100 of the above embodiment includes three composites of the blue, green and red display portions 130B, 130G and 130R. Accordingly, the writing time may be shortened and color images having good display properties may be displayed. Furthermore, in view of the difference in visibility among colors, the display portions are stacked in the order of blue, green and red from the viewing direction. The resulting liquid crystal display device may display images having good properties.

The film substrate 41 may be provided with an orientation control film having a pre-tilt angle of, for example, about 0.5° to 8°. This film allows the orientation directions of liquid crystal molecules to be aligned, so that bright images having a high contrast ratio may be displayed.

Although the above embodiment has illustrated composition X containing nematic liquid crystals A and B as an example of the composition, the composition is not limited to such a composition. Other liquid crystal compositions may produce the same effect as above.

In the above embodiment, the blue display portion 130B, the green display portion 130G, and the red display portion 130R are stacked on top of each other to display color images. However, the structure for displaying images is not limited to the above structure. For example, the liquid crystal display device may include a single layer panel that may display only monochrome images.

All examples and conditional language recited herein are intended for pedagogical purpose to aid the reader in understanding the invention and the concepts contributed by the inventor to furthering the art, and are to be construed as being without limitation to such specifically recited examples and conditions. Although the embodiments of the present inventions have been described in detail, it should be understood that the various changes, substitutions, and alterations could be made hereto without departing from the spirit and scope of the invention.

What is claimed is:

1. A liquid crystal display device comprising:
a liquid crystal layer containing a composition that includes a nematic liquid crystal and a chiral agent, the composition having properties satisfying η/Δε^{1/2}/E²≦1.0 and having a refractive index anisotropy of 0.23 or more, η representing the viscosity of the composition, Δε representing the dielectric constant anisotropy of the composition, and E representing the electric field intensity at which the state of the composition is changed from a planar state to a focal conic state; and
a pair of electrode substrates between which the liquid crystal layer is disposed, at least one of the electrode substrates being transparent.

2. The device according to claim 1,
wherein the composition has an isotropic phase transition temperature of at least 80° C.

3. The device according to claim 1, further comprising:
an orientation control film disposed between the chiral nematic liquid crystal layer and the electrode substrate through which light enters.

4. The device according to claim 1,
wherein the liquid crystal layer and the pair of electrode substrates define a composite, and wherein the device includes a plurality of composites whose liquid crystal layers contain respective compositions that selectively reflect light having different wavelengths.

5. The device according to claim 1,
wherein the compositions in the plurality of composites selectively reflect red light, green light and blue light, respectively.

6. The device according to claim 1,
wherein the plurality of composites are stacked in an order of composites reflecting blue light, green light and red light from a side through which light enters.

7. The device according to claim 2, further comprising:
an orientation control film disposed between the chiral nematic liquid crystal layer and the electrode substrate through which light enters.

8. The device according to claim 2,
wherein the layer and the pair of electrode substrates define a composite, and wherein the device includes a plurality of composites whose liquid crystal layers contain respective compositions that selectively reflect light having different wavelengths.

9. The device according to claim 2,
wherein the compositions in the plurality of composites selectively reflect red light, green light and blue light, respectively.

10. The device according to claim 2,
wherein the plurality of composites are stacked in an order of composites reflecting blue light, green light and red light from a side through which light enters.

11. The device according to claim 3,
wherein the liquid crystal layer and the pair of electrode substrates define a composite, and wherein the device includes a plurality of composites whose liquid crystal layers contain respective compositions that selectively reflect light having different wavelengths.

12. The device according to claim 3,
wherein the compositions in the plurality of composites selectively reflect red light, green light and blue light, respectively.

13. The device according to claim 3,
wherein the plurality of composites are stacked in an order of composites reflecting blue light, green light and red light from a side through which light enters.

14. A liquid crystal display device comprising:
a liquid crystal layer containing a composition that includes a nematic liquid crystal and a chiral agent, the composition having properties satisfying η/Δε^{1/2}≦23 and having a refractive index anisotropy of 0.23 or more, η representing the viscosity of the composition and Δε representing the dielectric constant anisotropy of the composition; and
a pair of electrode substrates between which the liquid crystal layer is disposed, at least one of the electrode substrates being transparent.

15. The device according to claim 14, further comprising:
an orientation control film disposed between the liquid crystal layer and the electrode substrate through which light enters.

16. The device according to claim 14,
wherein the liquid crystal layer and the pair of electrode substrates define a composite, and wherein the device includes a plurality of composites whose liquid crystal layers contain respective compositions that selectively reflect light having different wavelengths.

17. The device according to claim 14,
wherein the compositions in the plurality of composites selectively reflect red light, green light and blue light, respectively.

18. The device according to claim 14,
wherein the plurality of composites are stacked in an order of composites reflecting blue light, green light and red light from a side through which light enters.
